(19) United States
(12) Patent Application Publication
(10) Pub. No.: US 2015/0156154 A1
(43) Pub. Date: Jun. 4, 2015

(54) STORAGE AND RETRIEVAL OF ELECTRONIC MESSAGES USING LINKED RESOURCES

(71) Applicants: Daniel M. Russell, Palo Alto, CA (US); Richard C. Gossweiler, III, Sunnyvale, CA (US)

(72) Inventors: Daniel M. Russell, Palo Alto, CA (US); Richard C. Gossweiler, III, Sunnyvale, CA (US)

(73) Assignee: GOOGLE INC., Mountain View, CA (US)

(21) Appl. No.: 12/717,316

(22) Filed: Mar. 4, 2010

(51) Int. Cl. G06F 15/16; H04L 12/58; G10L 15/00; G06F 17/30

(52) U.S. Cl. CPC H04L 51/18; H04L 51/22

(57) ABSTRACT

Methods, systems, and apparatus, including computer programs encoded on a computer storage medium, for storing and retrieving electronic messages. In one aspect, a method includes receiving a query, searching summary representations of resources that are linked to by electronic messages, for matches with the query, selecting one or more of the electronic messages that link to the resources whose summary representations match the query, inferring information that references the selected messages, and providing the information that references the selected electronic messages.

### BACKGROUND

This specification relates to the storage and retrieval of electronic messages.

It is not uncommon for electronic messages, such as emails, instant messages, VoIP audio messages, text messages, facsimile messages, or blog or social network posts, to include links or other references to resources. For example, a sender of an email may paste a hyperlink that references a particular web resource into the subject line or body of the email. Among several types of data encoded in the hyperlink, a Uniform Resource Identifier (URI) associated with the web resource may be encoded as the link destination.

### SUMMARY

In general, one aspect of the subject matter described in this specification may be embodied in processes that are used for the storage and retrieval of electronic messages using linked resources. Initially, when an electronic message includes a link that references a particular resource, this specification refers to the particular resource as a “linked resource,” and refers to the content of the linked resource as “referenced content.” The referenced content of a resource that is used for the storage and retrieval processes may include all of the content of the resource, or information that is representative of the referenced content, such as a subset, extract, description, synopsis, snippet, or shortened version of the referenced content. In either case, a “summary representation” of the referenced content may be obtained for use in storing or retrieving the electronic messages where, as used by this specification, the “summary representation” of the referenced content may refer to the entire referenced content, or to information that is representative of the referenced content, such as a synopsis or extract of the referenced content.

The storage and retrieval processes may each be performed by electronic client communication devices associated with the sender or the recipient of the electronic message, or by a message transfer agent server that stores the electronic messages and/or that transfers the electronic messages from the electronic client communication device of the sender to the electronic client communication device of the recipient. Said another way, each of the electronic client communication devices and the message transfer agent server may include an index that is used for storing both the electronic messages and a summary representation of the referenced content associated with each electronic message, or that is used for retrieving particular electronic messages using the summary representation associated with each electronic message.

In the storage context, when a link is detected within an electronic message, a summary representation of the resource that is referenced by the link is obtained (i.e., is retrieved or generated). The summary representation is stored in association with the electronic message, for example by storing the summary representation in the electronic message itself as text or as metadata, or by storing the summary representation (or information identifying the summary representation) in an index that is used for locating and retrieving stored electronic messages.

In the retrieval context, query terms are received from a user, and an index is queried using the query terms. The index stores electronic messages and, for those electronic messages that include one or more links, a summary representation of the resource that is referenced by the link. Electronic messages that a search engine identifies as satisfying the query are identified to the user. For instance, the search engine may identify an electronic message as satisfying the query when the query terms are included in the body or subject line of the electronic message, or when the query terms are found in a summary representation that is associated with a link that is included in the body or subject line of the electronic message. Because the summary representation of the resource is stored in association with the electronic message, the electronic message will be identified to the user regardless of whether the terms are included as content of the electronic message itself or as content of a resource which is linked-to by the electronic message.

In general, another aspect of the subject matter described in this specification may be embodied in methods that include the actions of receiving a query, searching summary representations of resources that are linked to by electronic messages, for matches with the query, identifying one or more of the electronic messages that link to the resources whose summary representations match the query, and providing information that identifies the one or more of the electronic messages.

In general, another aspect of the subject matter described in this specification may be embodied in methods that include the actions of receiving a query, searching summary representations of resources that are linked to by electronic messages, for matches with the query, selecting one or more of the electronic messages that link to the resources whose summary representations match the query, inferring information that references the selected messages, and providing the information that references the selected electronic messages.

Other embodiments of these aspects include corresponding systems, apparatus, and computer programs, configured to perform the actions of the methods, encoded on computer storage devices.

These and other embodiments may each optionally include one or more of the following features. For instance, the actions may include determining that an electronic message includes a link to a resource, obtaining a summary representation of the resource, and storing the summary representation in association with the electronic message; storing the summary representation in association with the electronic message may further include integrating the summary representation with the electronic message, as body content of the electronic message, as an attachment to the electronic message, or as a pointer to metadata associated with the electronic message; storing the summary representation in association with the electronic message may further include storing the summary representation in an index with the electronic message; storing the summary representation in association with the electronic message may include an electronic client communication device of a sender or a recipient of the electronic message storing the summary representation in association with the electronic message; storing the summary representation in association with the electronic message may include a server associated with a message transfer agent storing the summary representation in association with the electronic message; obtaining the summary representation may include performing a speech recognition operation on the resource, and establishing, as the summary representation, a result of the speech recognition operation; obtaining the summary representation may include obtaining, as the summary representation, a description of or an excerpt from the resource, one or more most frequently occurring terms from the resource, a feature vector associated with the resource, or an automatically-generated description of an image using the resource; obtaining the summary representation may include selecting a summarization rule associated with the link, applying the summarization rule associated with the particular link, to the resource, and establishing, as the summary representation, a result of applying the summarization rule to the resource; obtaining the summary representation may include generating the summary representation after determining that the electronic message includes one or more links to one or more resources; and/or obtaining the summary representation may include obtaining a summary representation from among a collection of summary representations that are stored in a repository.

In general, another aspect of the subject matter described in this specification may be embodied in methods that include the actions of determining that an electronic message includes one or more links to one or more resources, obtaining a summary representation of one or more of the resources, and associating the summary representation with the electronic message. Other embodiments of this aspect include corresponding systems, apparatus, and computer programs, configured to perform the actions of the methods, encoded on computer storage devices.

These and other embodiments may each optionally include one or more of the following features. For instance, associating the summary representation with the electronic message may further include integrating the summary representation with the electronic message, as body content of the electronic message, as an attachment to the electronic message, or as a pointer to metadata associated with the electronic message; associating the summary representation with the electronic message may further include indexing the summary representation in association with the electronic message; the summary representation may be associated with the electronic message by an electronic client communication device of a sender or a recipient of the electronic message; the summary representation may be associated with the electronic message by a server associated with a message transfer agent; obtaining the summary representation may further include performing a speech recognition operation on the one or more of the resources, obtaining a description of or an excerpt from the one or more of the resources, or selecting one or more most frequently occurring terms from the one or more of the resources; obtaining the summary representation may include selecting a summarization rule associated with a particular link, and applying the summarization rule associated with the particular link, to the resource referenced by the particular link; obtaining the summary representation may include obtaining a feature vector associated with one or more of the resources, obtaining an automatically-generated description of an image using the one or more of the resources, generating the summary representation responsive to determining that the electronic message includes one or more links to one or more resources, or obtaining a summary representation that pre-exists the determination that the electronic message includes the one or more links to the one or more resources; determining that the electronic message includes one or more links to one or more resources may include determining, before sending the electronic message, that a sender of the electronic message has entered a link to a resource into the electronic message; determining that the electronic message includes one or more links to one or more resources may include determining that the electronic message includes predefined tokens that are indicative of a link; and/or fewer than all of the one or more sources may be selected as a subset of the one or more resources, where the summary representation may be obtained only for the resources of the subset.

In general, another aspect of the subject matter described in this specification may be embodied in methods that include the actions of identifying one or more links to one or more resources in an electronic message, generating a summary representation of one or more of the resources, and storing the summary representation with the electronic message. Other embodiments of this aspect include corresponding systems, apparatus, and computer programs, configured to perform the actions of the methods, encoded on computer storage devices.

In general, another aspect of the subject matter described in this specification may be embodied in methods that include the actions of generating a summary representation of one or more resources that are linked-to in an electronic message, and storing the summary representation in association with the electronic message. Other embodiments of this aspect include corresponding systems, apparatus, and computer programs, configured to perform the actions of the methods, encoded on computer storage devices.

In general, another aspect of the subject matter described in this specification may be embodied in methods that include the actions of obtaining a query term, performing a query using an index and the query term, wherein the index stores electronic messages and, for particular electronic messages that include one or more links to one or more resources, a summary representation of one or more of the resources in association with the respective, particular electronic message, and providing information identifying one or more electronic messages that satisfy the query. Other embodiments of this aspect include corresponding systems, apparatus, and computer programs, configured to perform the actions of the methods, encoded on computer storage devices.

These and other embodiments may each optionally include one or more of the following features. For instance, performing the query may further include determining that the query terms are included in the one or more electronic messages, or that the query terms are included in a respective summary representation that is stored in association with the one or more electronic messages.

The details of one or more embodiments of the subject matter described in this specification are set forth in the accompanying drawings and the description, below. Other features, aspects and advantages of the subject matter will be apparent from the description and drawings, and from the claims.

### BRIEF DESCRIPTION OF THE DRAWINGS

FIG. 1 is a diagram illustrating the storage and retrieval of electronic messages using linked resources.

FIG. 2 is a diagram of an example system.

FIGS. 3 and 4 are flowcharts of example processes.

FIGS. 5 and 6 illustrate example electronic messages and associated data.

FIGS. 7A and 7B illustrate example email messages including linked resources.

FIG. 8 illustrates an example electronic messages search results interface including a result with linked resources.

Like reference numbers and designations in the various drawings indicate like elements.

### DETAILED DESCRIPTION

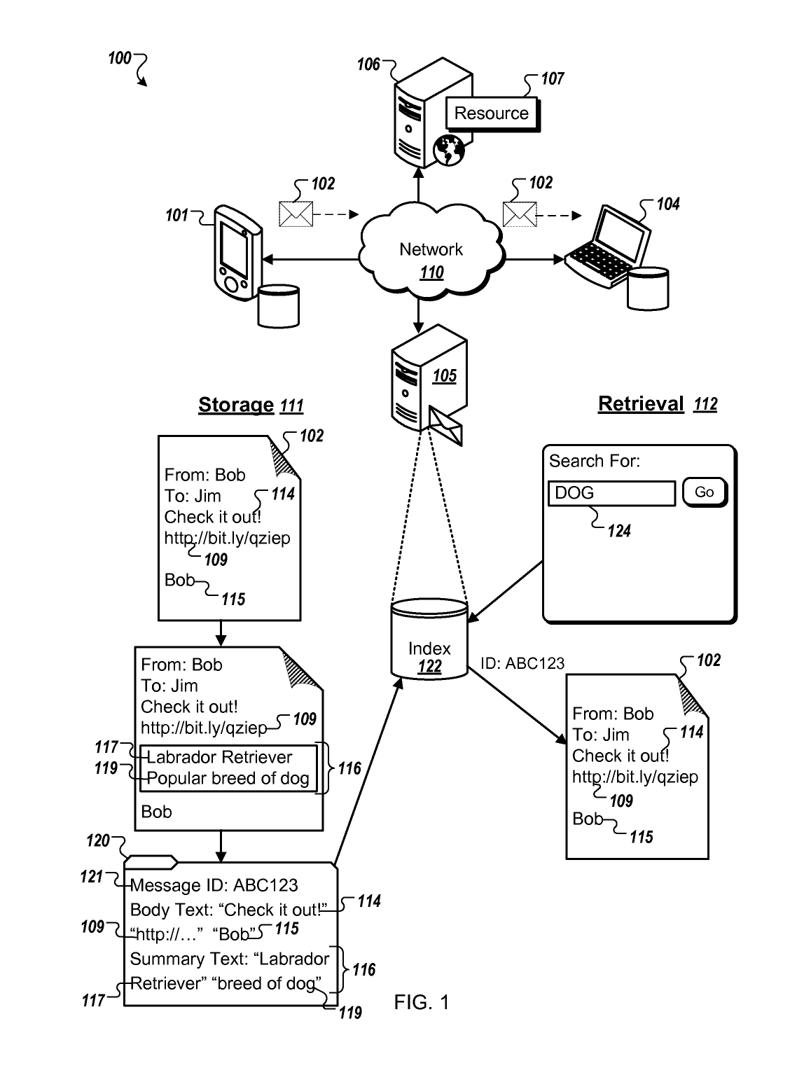

FIG. 1 is a diagram illustrating the storage and retrieval of electronic messages using linked resources. Specifically, an example system 100 includes an electronic client communication device 101 associated with a sender of an electronic message 102, an electronic client communication device 104 associated with a recipient of the electronic message 102, a server 105 associated with a message transfer agent that transfers the electronic message 102 from the electronic client communication device 101 to the electronic client communication device 104, and a web server 106 that includes a resource 107 that is referenced by a link 109 that is included in the electronic message 102.

The electronic client communication device 101, the electronic client communication device 104, the server 105, and the web server 106 are connected to each other by a network 110, which may be, for example, a private network (e.g., an intranet), a public network (e.g., the Internet), or some combination thereof. Furthermore, the electronic communication device 101, the electronic communication device 104, and/or the server 105 may each include an index that is used for the storage and retrieval of electronic messages.

Oftentimes links themselves are encoded with little or no information that may be used to infer the content of the resource to which it refers, particularly when a shortening technique has been applied to reduce the link destination to the fewest number of characters. In one example, an email may include no other content than a link to the URL <http://bit. ly/92iep> or the URL <http://en.wikipedia.org/wiki/Labrador_retriever>, where both URLs actually refer to the same web page.

By reviewing the URLs encoded in the link alone, a recipient of this example email is unlikely to be able to infer the content of the web page from the former URL, but might infer from the latter URL that the web page relates in some way to a “breed overview,” or to “dogs” or “pets.” If, at a later time, the recipient were to attempt to locate this email with a simple text search using the terms “breed overview” or “dog,” this particular email would not be found because those terms themselves are not encoded in the link and are not otherwise included in the content of the email.

According to one general implementation, the ability to search electronic messages is improved through the use of an enhanced storage process 111 and an enhanced retrieval process 112, which may both be performed by the example system 100. In general, during the storage process 111, for electronic messages that include links to resources, the link to the resource is resolved, a summary representation is obtained, and the summary representation is associated with the electronic message, for example as an email attachment or as metadata associated with an indexed text message record. In some examples, a linked resource may include a web page, song, movie, voice mail recording, image, or other graphical, audio, or multimedia digital content.

In further detail, the electronic message 102, an email, is sent from sender “Bob,” associated with the electronic client communication device 101, to recipient “Jim,” associated with the electronic client communication device 104. The electronic message 102 is delivered over the network 110, using the server 105 that is associated with an email provider. The electronic message 102 includes body text “Check it out!!” 114 and body text “Bob” 115, and a link 109 that the user may have pasted or typed into the electronic message 102.

Before the sender initiates the sending of the electronic message 102, the electronic client communication device 101 recognizes that the electronic client electronic message 102 includes a link. For example, the electronic client communication device 101 may recognize the text “http://” or “bit.ly” of the link 109, and infer that this text is a token that is indicative of a link. As used herein, a token that is indicative of a link may be to a keyword (“Check out this link!”), a file extension (e.g., .mpg, .html, .wav, etc.), a protocol indicator (e.g., http, https, ftp, etc.), a host name (e.g., facebook, youtube, myspace, wikipedia, etc.), a top-level domain extension (e.g., .com, .org, .edu, .net, .mil, .gov, .biz, etc.), an Internet Protocol (IP) address, or a combination of one or more of them.

When the link 109 is detected, the electronic client communication device 101 resolves the link 109 and dynamically generates a summary representation 116 (or accesses an existing summary representation) of the resource 107 to which the link 109 refers. In the illustrated example, the electronic client communication device 101 has determined that the most relevant (e.g., most frequently occurring, or most representative) terms that occur in the resource 107 referred to by the link 109 include the term “Labrador Retriever” 117, and the term “Popular Breed of Dog” 119. Based on this determination, the electronic client communication device 101 may establish these two terms as the summary representation 116 of the resource 107 that is referred to by the link 109. Other types of summary representations could also be obtained or used, such as by automatically generating an extract or synopsis of the resource, or by obtaining tags or comments that are manually applied to or associated with a resource by other users.

The summary representation 116 is integrated with the electronic message 102. In FIG. 1, for instance, the summary representation 116 is introduced into the body of the electronic message 102, visible immediately below the link 109. In an alternate implementation, the summary representation 116 is introduced into the body of the electronic message 102, visible at the top or bottom of the electronic message 102. In a further alternative implementation, the summary representation is included as an attachment to the electronic message 102, or is stored as invisible metadata (or a pointer to metadata) that is associated with the electronic message 102.

The electronic message 102 may be indexed in association with the summary representation 116. For instance, an index entry 120 stores, in index 122, identification information 121 that uniquely identifies the electronic message 102, stores body text 114 and 115 as well as the text of the link 109, and stores the summary representation 116, including the terms 117 and 119. The index may be used to later infer information that identifies or references the electronic messages that are associated with a particular summary representation.

During the retrieval process 112, searches may return electronic messages based on matches located, in part, within the summary representation associated with the electronic message. Specifically, when the sender or the recipient of the electronic message 102 searches the index 122, the search may access the summary representation stored for each electronic message in order to determine the relevance of each electronic message. For instance, when the sender or the recipient searches for an electronic message using the query term “dog” 124, the electronic message 102 is returned since the query term 124 is included in the summary representation 116 associated with the electronic message 102, even though the query term 124 is not included in the body text 114 and 115 of the electronic message 102 itself or within the text of the linked resource 109.

Although the example storage and retrieval processes 111, 112 have been described as occurring by the electronic client communication device 101 associated with the sender, in other implementations these processes are performed, in whole or part, at the electronic client communication device 104 associated with the recipient, or at the server 105.

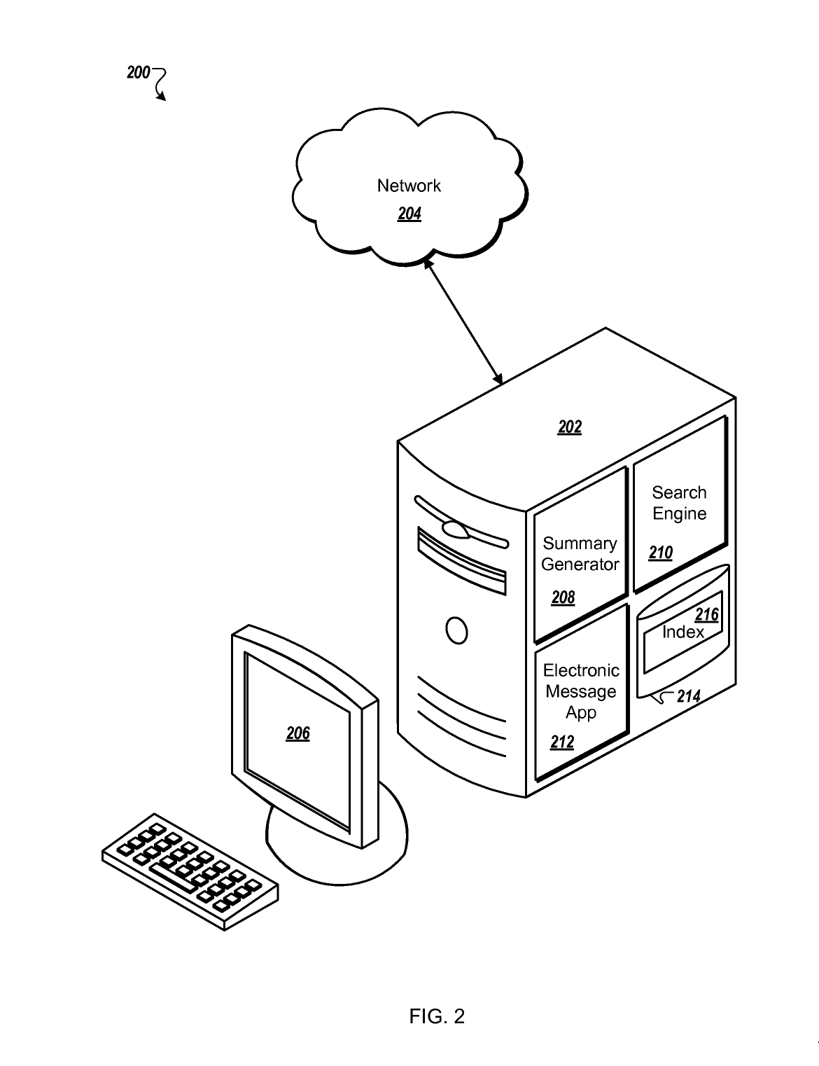

FIG. 2 is a diagram of an example system 200. The system 200 may be used to resolve a linked resource within an electronic message and obtain a summary representation of the referenced content to associate with the electronic message. As an overview, the system 200 includes a computing device 202, installed with a summary generator 208 for creating summary representations of linked resources, a search engine 210 for locating an electronic resource, an electronic message application 212 for creating, sending, and receiving electronic messages, and a storage medium 214, that may be used by the electronic message application 212 for managing electronic messages. The computing device 202 is in communication with a network 204. A user may interact with the computing device 202 either directly through a user interface 206 or remotely connected to the computing device 202 by another computing device via the network 204.

When executing the electronic message application 212, a user may create a new electronic message that links to a resource, such as by entering the URL of a video file. The electronic message application 212 may recognize the linked resource due to one or more tokens within the linked resource, such as “http,” “www,” or “.org.” The electronic message application 212 may generate a summary representation of the information within the referenced content using the summary generator 208. If, for example, the linked resource is a voice mail message, the summary generator may use a speech recognition operation on an audio file stored locally within the storage device 214 or otherwise directly accessible to the computing device 202 (e.g., via another internal storage drive, an external storage drive, or a networked storage drive) to generate a text version of the audio message. If the linked resource is a web page, the summary generator 208 may locate a cached copy of the web page within a storage location such as the storage device 214 or use the search engine 210 or another web server interface function to retrieve the referenced content or information regarding the referenced content from a web server available through the network 204.

In some implementations, the link may be incomplete, such as when a user refers to a resource without supplying a URL. For instance, when referring to a specific video, a user may type the term “Bubblegumtwoshoes on Hulu,” into an electronic message. In this case, the summary generator 208 may attempt to derive a full URL for the referenced content, inferring the existence of a link from the text “Hulu” within the electronic message. For example, the summary generator 208 could use the search engine 210 to locate a multimedia file on the web site Hulu including the text “bubblegumtwoshoes” within the name or description, or a summary page including multiple related videos for bubblegumtwoshoes (e.g., episodes of a video program). In the situation where a particular term has multiple meanings (e.g., a “chip” could refer to “chocolate” or “silicon”), the context of the email thread could help disambiguate the meaning of the term.

Once the summary generator 208 has located information regarding the referenced content, the summary generator 208 may use any appropriate number of summarization techniques to generate a summary representation of the referenced content. For instance, generating a summary representation may include identifying the most common terms within the referenced content, obtaining a synopsis or extract of the referenced content, obtaining tags or comments that are manually associated with the resource by other users, parsing descriptive metadata included within the resource, obtaining a thumbnail image of the referenced content, or generating or obtaining a feature vector associated with the resource.

The electronic message application 212 may attach the summary representation to the electronic message before sending the message to the recipient. In some implementations, this may include attaching the summary representation as metadata or a file attachment to the outgoing electronic message. In other implementations, the summary representation may be embedded within the electronic message itself, such as inline with the text of the linked resource or at the bottom of the electronic message. If the summary representation is visible to the user, the user may have the opportunity to modify the contents of the summary representation or to correct an error within the linked resource if the summary representation fails to match the content that the user intended to reference.

If the computing device 202 saves a copy of the electronic message upon sending, for example within a “sent mail” folder maintained by the electronic message application 212, the saved information may be included within an index 216 stored upon the storage device 214. The index, for example, may include a reference to the electronic message, along with both the composition created by the user (e.g., body text, graphics, audio, etc.) as well as the summary representation generated by the summary generator 208 or a reference to a resource linked-to by the electronic message.

Similarly, upon receiving an electronic message, the electronic message application 212 may identify and resolve any appropriate linked resources using the summary generator 208 and the search engine 210 and include this information within the index 216.

At a later time, when the user is searching for information regarding the electronic message, query terms entered into the electronic message application 212 or directly to the search engine 210 may be used to search both the user composition portion of the electronic message and the summary representation of the linked resource included within the index entry corresponding to the electronic message. For example, although “bubblegumtwoshoes” contains no reference or inference to being related to zoo animals, the referenced content may pertain to a video of a trained dolphin named “Bubble Gum Two Shoes.” When performing a search using the query term “dolphin,” the electronic message will be retrieved because that term occurs in the summary representation, even though that term does not occur within the composed message itself. The summary representation may be generated before or after the query terms are entered.

Although the system 200 includes the summary generator 208 within the same computing device 202 as the electronic message application 212, in some implementations, the summary generator 208 and, optionally, the index 216 are included within an electronic message server connected to the computing device 202 via the network 204.

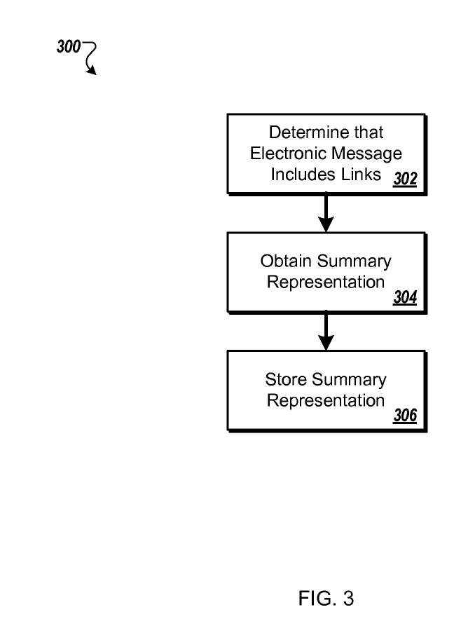

FIG. 3 is a flowchart of an example storage process 300. Briefly, the process 300 includes the actions of determining that an electronic message includes one or more links to one or more resources, obtaining a summary representation of one or more of the resources, and associating the summary representation with the electronic message.

In more detail, when the process 300 begins, it is determined that an electronic message includes one or more links to one or more resources (302). Determining that the electronic message includes one or more links to one or more resources may further include determining, before sending the electronic message, that a sender of the electronic message has entered a link to a resource into the electronic message (e.g., a complete URL, a voice mail attachment, an inserted hyperlink), or determining that the electronic message includes predefined tokens that are indicative of a link. Fewer than the all of linked resources may be selected as a subset of the one or more resources.

A summary representation of one or more of the resources is obtained (304). Obtaining the summary representation may further include performing a speech recognition operation on the one or more of the resources, obtaining a “snippet,” or description of or an excerpt from the one or more of the resources, selecting one or more of the most frequently occurring terms from the one or more of the resources, obtaining a feature vector associated with one or more of the resources, or obtaining an automatically-generated description of an image using the one or more of the resources. When a subset of the links has been selected, the summary representation may be obtained only for the resources of the subset.

Where the resource is an image or video, the URI of the image or video, or the meta-data associated with the image or video, may be used by the search engine to locate the image in a web resource on the Internet. Information from the web resource may be used to derive a summary representation of the image. Alternatively, images or videos can be “fingerprinted” or identified based on a set of features, and then compared with other images. Exact and close matches may then support the generation of a summary representation of the image.

In some implementations, obtaining the summary representation may further include generating the summary representation responsive to determining that the electronic message includes one or more links to one or more resources, or obtaining a summary representation that pre-exists the determination that the electronic message includes the one or more links to the one or more resources. In some examples, the summary representation may have already been generated in relation to a previously sent electronic message (e.g., forwarding a URL to a friend after having forwarded the same URL to a family member), or the summary representation may be provided by a search engine, web crawler, or other networked service that maintains summary representations of digital content.

Additionally, obtaining the summary representation may further include selecting a summarization rule associated with a particular link, and applying the summarization rule associated with the particular link, to the resource referenced by the particular link. The summarization rule, for example, may be included within the user settings options of the electronic message application. In some implementations, summarization rules may include both how a summary representation is to be included within an electronic message (e.g., inline, as an attachment, as metadata, etc.) as well as the level of information provided within the summary representation (e.g., short list of keywords, descriptive synopsis, thumbnail image in addition to textual information, etc.). The settings may differ depending upon the type of linked resource (e.g., voice mail, web page, movie, image, etc.). For example, a user may select to allow inline summary representations of web page URLs, but no summary representation of voice mail attachments.

The summary representation is associated with the electronic message (306), and the process 300 ends. Associating the summary representation with the electronic message may further include integrating the summary representation with the electronic message, as body content of the electronic message, as an attachment to the electronic message, or as a pointer to metadata associated with the electronic message.

Alternatively, associating the summary representation with the electronic message may further include indexing the summary representation in association with the electronic message. The summary representation may be associated with the electronic message by an electronic client communication device of a sender or a recipient of the electronic message, or by a server associated with a message transfer agent.

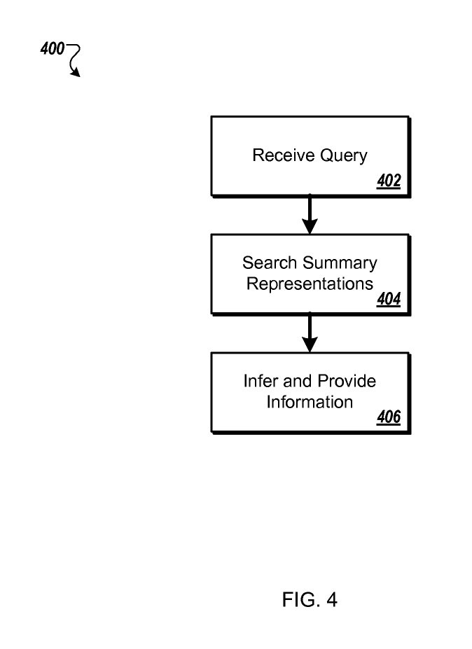

FIG. 4 is a flowchart of an example retrieval process 400. Briefly, the process 400 includes the actions of receiving a query, searching summary representations of resources that are linked to by electronic messages, for matches with the query, selecting one or more of the electronic messages that link to the resources whose summary representations match the query, inferring information that references the selected messages, and providing the information that references the selected electronic messages.

In more detail, when the process 400 begins, a query is received (402). The query, in some examples, may include one or more keywords, tokens, audio snippets, or images. In some implementations, a query term in graphic or audio format may be interpreted, for example using speech to text translation or a feature vector, into a query term (e.g., feature vector, one or more keywords, etc.) appropriate to query performance.

Summary representations of resources that are linked to by electronic messages are searched for matches with the query (404). An index stores electronic messages and, for particular electronic messages that include one or more links to one or more resources, a summary representation of one or more of the resources in association with the respective, particular electronic message. Searching for matches may include determining that query terms are included in the one or more electronic messages, that query terms are included in a respective summary representation that is stored in association with the one or more electronic messages, or a combination thereof. In some implementations, a relevance factor may be applied for terms that are related rather than exact matches. For example, an electronic message having a summary representation including the term “canine” may be located in response to the query term “dog.”

One or more of the electronic messages that link to the resources whose summary representations match the query are selected, and information that identifies the one or more of the electronic messages is inferred and/or provided (406), thereby ending the process 400. For example, one or more electronic messages or links to electronic messages that satisfy the query may be identified based on the summary representations that match the query, based on the links, or based on the resources. The information that identifies the electronic messages that satisfy the query presented to the user. For instance, using particular identified summary representations, information identifying or referring to electronic messages can be determined or inferred using an index that stores the information in association with summary representations that are associated with the electronic messages.

If more than one electronic message has been selected, the query results may be sorted for the user in order of relevance. This order of relevance, for example, may include promotion of query results resulting to detected matches within body text of email messages rather than summary representations of linked resources.

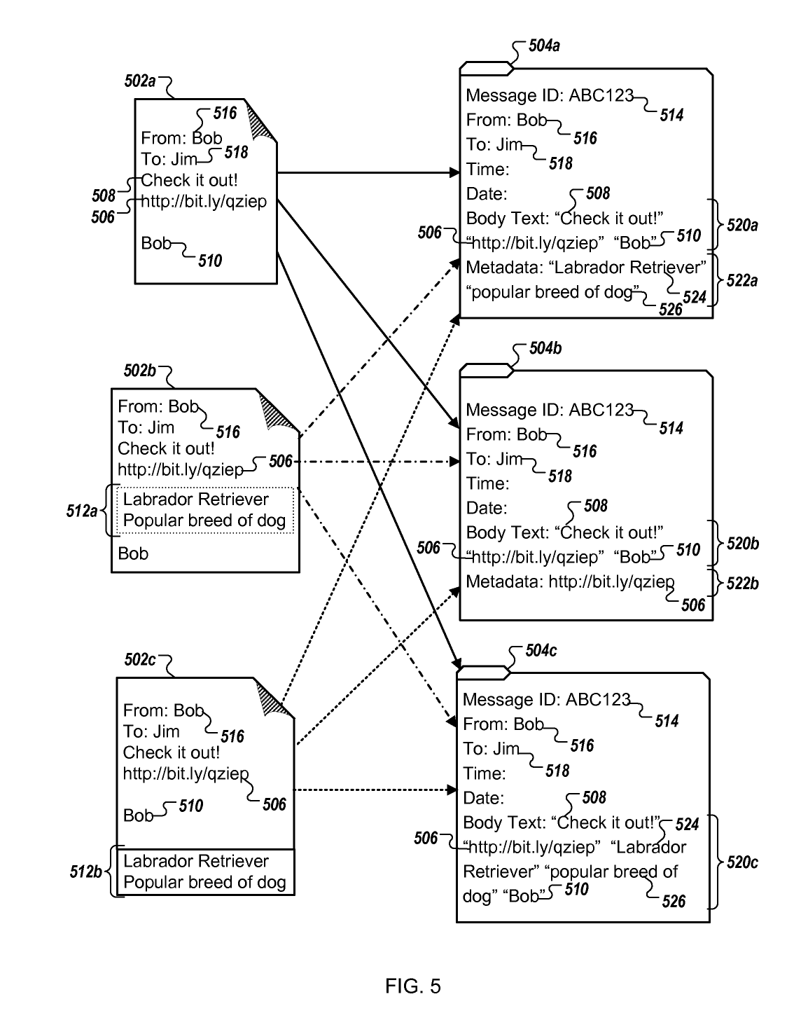

FIG. 5 illustrates example electronic messages 502 and associated index entries 504. In general, the electronic messages 502 illustrate different manners in presenting the same information, while the index entries 504 illustrate that, regardless of how the information is presented within the electronic messages 502, that same information may be stored in a number of formats within a searchable index, such as the index 216 as described in relation to FIG. 2. The electronic messages 502 each include a linked resource 506, namely the URL <http://bitly/qziep>. The index entries 504 each include a message identifier 514, a sender 516, a recipient 518, and a body text region 520. The indexed entries 504 may optionally include a metadata region 522.

A first electronic message 502a includes the sender “Bob” 516, the recipient “Jim” 518, a message “check it out” 508, a signature “Bob” 510, and the linked resource 506. Although no information is provided within the first electronic message 502a regarding the contents of the linked resource 506, the linked resource 506 may be resolved into a summary representation in the form of metadata. This metadata may be associated with the first electronic message 502a, for example as a file attachment or pointer.

The first electronic message 502a may be stored within any of the example index entry formats, as illustrated by the index entries 504. For example, as illustrated within a first index entry 504a, a metadata region 522a includes a first phrase “Labrador Retriever” 524 and a second phrase “popular breed of dog” 526. This metadata, in some examples, may include descriptive information located within the referenced content of the linked resource 506, a summary representation the referenced content, or the first text region within the referenced content. When executing a search upon an index, the text included within the metadata region 522a may or may not be treated differently than the text included within the body text region 520a (e.g., the message 508, the linked resource 506, and the signature 510). For example, the search may promote results that pertain to body text over those that pertain to metadata.

In another example, the first electronic message 502a may be stored within an index using a second index entry 504b that includes the URL of the linked resource 506 within a metadata region 522b. In this circumstance, the linked resource 506 may not be resolved to a summary representation until the point when a search is being run. In other implementations, the summary representation of the metadata <http://bit.ly/qziep> may be stored within a different file. For example, if the URL is used as a linked resource within multiple electronic messages, rather than including the summary representation within the index entry for each of the electronic messages, a single index entry may be created for the summary representation, and each of the index entries may reference the index entry of the summary representation.

Finally, the first electronic message 502a may be stored in the format illustrated within a third index entry 504c, including the summary representation of the linked resource 506 as a portion of the body text within a body text region 520c. For example, the body text region 520c includes the phrases “Labrador Retriever” 524 and “popular breed of dog” 526. In this example, during a search of the index, the summary representation of the linked resource 506 may be treated no differently than the body text 508 and 510 or the linked reference 506.

A second electronic message 502b and a third electronic message 502c illustrate formats in which a summary representation 512 of the linked resource 506 may be introduced into the electronic message text area. For example, within the second electronic message 502b, a summary representation region 512a includes the text “Labrador Retriever Popular breed of dog.” In some implementations, the summary representation region 512a may be treated as hypertext, selectable to retrieve the referenced content. The summary representation region 512a, in some implementations, may be presented in a different font setting (e.g., color, size, style, etc.) than the body text, offset by a different background color, surrounded by a graphic frame, or otherwise made to appear separate from the section of the electronic message 502b written by the sender 516. In some implementations, the summary representation region 512a may include graphic information, such as an image of a Labrador Retriever from the referenced content, a thumbnail image of the referenced content (e.g., web page), or an icon used to flag the text included within the summary representation region 512a as being automatically-generated summary text.

The third electronic message 502c includes a summary representation region 512b at the bottom of the electronic message 502c (e.g., beneath the signature 510). As illustrated, a line separates the summary representation region 512b from the body of the third electronic message 502c that was authored by the sender 516. In some implementations, the choice between adding a summary representation inline, as illustrated in the second electronic message 502b or appended to the bottom, as illustrated in the third electronic message 502c, may be decided within user options available through the electronic message application. In other implementations, placement of the summary representation may depend upon the nature of the referenced content or the number of linked resources included. For example, if three or more linked resources are added within a particular electronic message, it may appear too cluttered to list all of the summary representations inline. If, in another example, the referenced content is a voice mail message, a summary representation (or first few sentences of the voice mail message) may be appended to the bottom, while a summary representation of a web page may be added inline with the body text. As with the first electronic message 502a, both the second electronic message 502b and the third electronic message 502c may be stored within an index using any of the illustrated exemplary index entries 504.

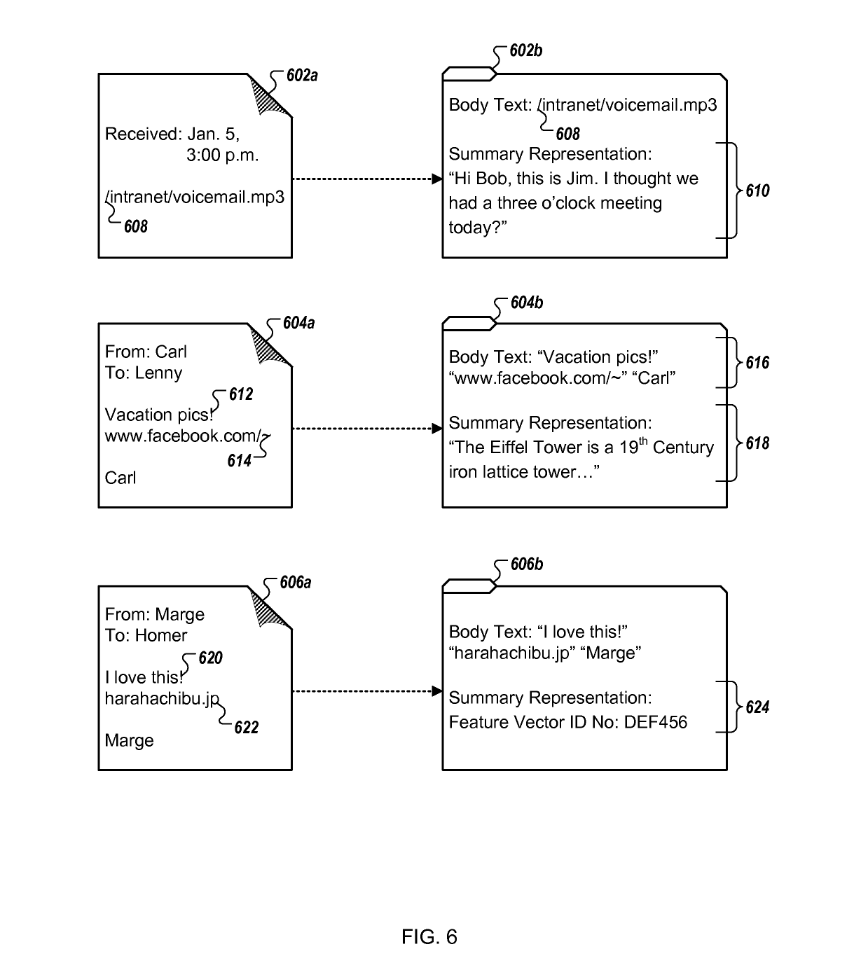

FIG. 6 illustrates example electronic messages and associated data. Briefly, the electronic messages include various styles of linked resources, along with associated index entries that include summary representations of the referenced content within the electronic messages. The electronic messages and index entries, for example, may be included in the system 100 described in relation to FIG. 1.

A first electronic message 602a includes a voicemail file referenced by a linked resource “/intranet/voicemail.mp3” 608. The linked resource 608, for example, includes a file directory path accessible to the recipient through an Intranet-mapped drive. Within an associated index entry 602b, the linked resource 608 is resolved to a summary representation 610 including the following text: “Hi Bob, this is Jim. I thought we had a three o'clock meeting today?” In some implementations, the summary representation 610 includes only a portion of the voice mail message referenced by the linked resource 608. Although not illustrated, a portion of the summary representation 610, in other implementations, may also be included within the first electronic message 602a, for example using one of the formats illustrated within the electronic message 502 described in relation to FIG. 2.

A second electronic message 604a includes a partial URL 614 beneath a message “vacation pics!” 612. Although the partial URL 614 does not include the “http://” portion, in some implementations, the electronic message application may append or prepend missing information to complete a suspected linked resource. In some examples, common URL tokens such as “http://”, “www”, “.com”, or “.html” may be added back into a partial URL to generate an address that an web browser could resolve. Any of the tokens within the partial URL 614, namely “www”, “facebook”, and “.com”, alone or in combination, could be recognized by the electronic message application as a linked resource when searching for linked resources within the second electronic message 604a.

As shown in a second index entry 604b, a body text region 616 includes the phrases: “Vacation pics!”, “www.facebook.com/˜”, and “Carl.” A summary representation 618 includes the phrase “The Eiffel Tower is a 19^{th} Century iron lattice tower.” The summary representation 618 or one or more thumbnail images obtained from the partial URL 614 may also be attached to the electronic message 604a.

In some implementations, the summary representation 618 includes text from the referenced content. For example, metadata within one or more of the vacation pictures or comments included with the vacation pictures, may indicate the actual phrase used within the summary representation 618.

In other implementations, one or more images may be mined for metadata, processed into feature vectors, or otherwise manipulated to determine the contents of the image as precisely as possible. For example, the Eiffel tower could be recognized using feature vector or other image recognition technique, and a summary regarding the Eiffel Tower obtained elsewhere (e.g., an online encyclopedia or other reference literature). The body text 612 may optionally be considered for clues when determining image content. In addition to or instead of the summary representation phrase, one or more image feature vectors may be included within the summary representation 618.

A third electronic message 606a includes a body text message “I love this!” 620 as well as a partial URL 622 “harahachibu.jp.” In this example, one or more tokens may be prepended to the partial URL 622 to generate a URL that may be resolved, for example, by an web browser. For example, both the token “http://” and the token “www” may be prepended to the partial URL 622, resulting in the complete URL <http://harahachibu.jp>.

The body text message 620 provides no indication regarding the nature of the referenced content. Within a third index entry 606b, a summary representation 624 includes a feature vector ID DEF456. The electronic message application may have resolved the partial URL 622 as a feature vector, in some examples, because the referenced content includes only graphical information, because any appropriate textual information within the referenced content is in the Japanese language, or because the electronic message application was unable to determine a theme or commonality that summarized the referenced content. In other implementations, the electronic message application may use translation software to translate foreign language resources into equivalent English.

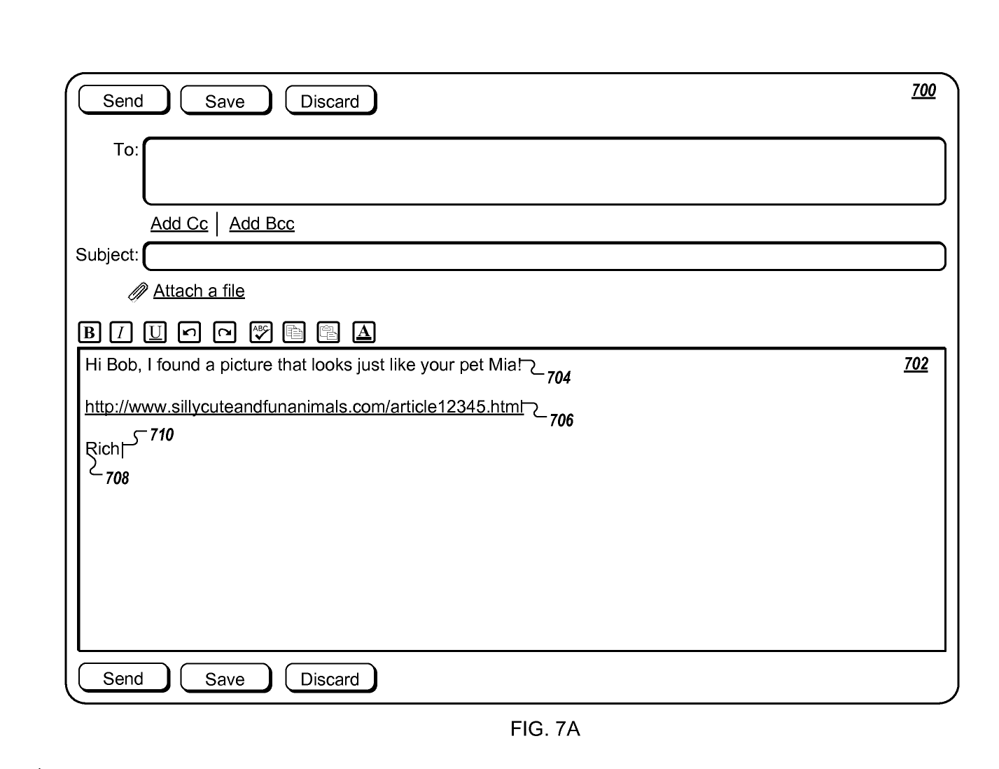

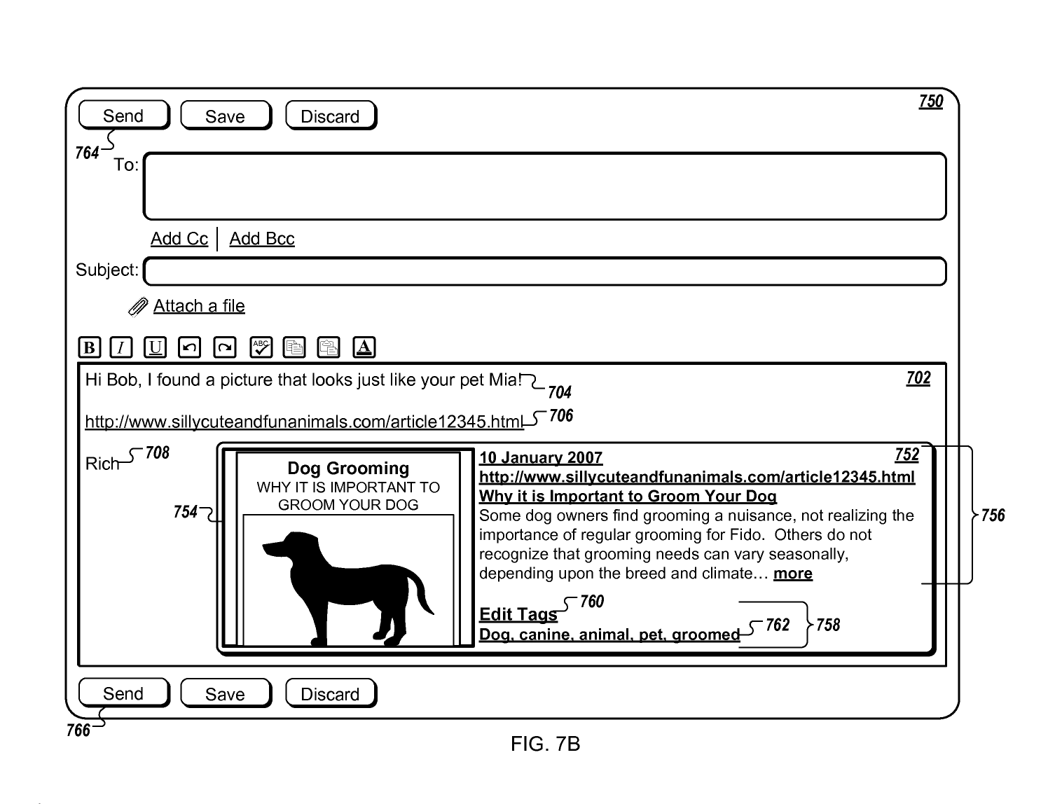

FIGS. 7A and 7B illustrate example email messages including linked resources. Briefly, the following figures illustrate the generation of a new email message including a linked resource within an electronic message application screen. The linked resource is resolved by the electronic message application, and a summary representation is associated with the new email message.

As shown in FIG. 7A, a screen shot 700 of an electronic message application composition interface includes a body text area 702 including a message 704 “Hi Bob, I found a picture that looks just like your pet Mia!”, a linked resource 706 <http://www.sillycuteandfunanimals.com/article12345.html>, and a signature 708 “Rich.” Next to the signature 708, a cursor 710 indicates that the sender is currently editing the new email message.

As shown in FIG. 7B, a screen shot 750 includes, within the body text area 702, the message 704, the linked resource 706, and the signature 708, as well as a summary representation box 752 aligned to the right of the signature 708. The screen shot 750, for example, may have been generated in response to selection of a send button 764 or 766, in a similar manner as selecting the send button 764 or 766 may launch a spell checking function to verify the body text before sending the email message. In another example, the summary representation box 752 may be generated upon entry of the linked resource 706 (e.g., entering a space or carriage return after entering the URL) into the body text area 702. In other implementations, the summary representation box 752 may be added to the email message at the point of transfer within a message handling server or when received by the recipient.

The summary representation box 752 contains information derived through resolving the linked resource 706. The summary representation box 752 includes a thumbnail representation 754 of the referenced content to the left of a snippet 756 of the referenced content. For example, the snippet 756 may include the first few sentences within the article referenced by the linked resource 706. In other implementations, the summary representation box 752 may include a photo located within the referenced content. For example, because the message 704 indicates “picture”, the summary representation generator may attempt to determine a specific photo indicated by the sender (e.g., if only one photo exists on the page).

Beneath the snippet 756, a tags region 758 includes a series of tokens that describe the referenced content. An edit tags link 760, when selected, may provide the sender with the opportunity to modify one or more of the tokens listed within a set of tags 762. The set of tags 762 include the tokens dog, canine, animal, pet, and groomed. The set of tags 762, for example, may have been located within the meta tags area of the HTML used to generate the referenced content. In another example, a summary generator may have generated the tags based upon the most common terms located within the article. When generating the index entry associated with the new email message, the set of tags 762 may be included within the summary representation for search purposes.

In some implementations, only the set of tags 762 is included within the associated index entry. In other implementations, a portion of the contents of the thumbnail representation 754, the snippet 756, or additional information within the referenced content may be added to the summary representation within the index entry. The tags region 758, for example, may only be used for editing purposes (e.g., before associating the tags 762 with the index entry). When the new email message is sent to the recipient, for example, the information within the set of tags 762 may be attached to the email message as metadata or not included within the new email message at all.

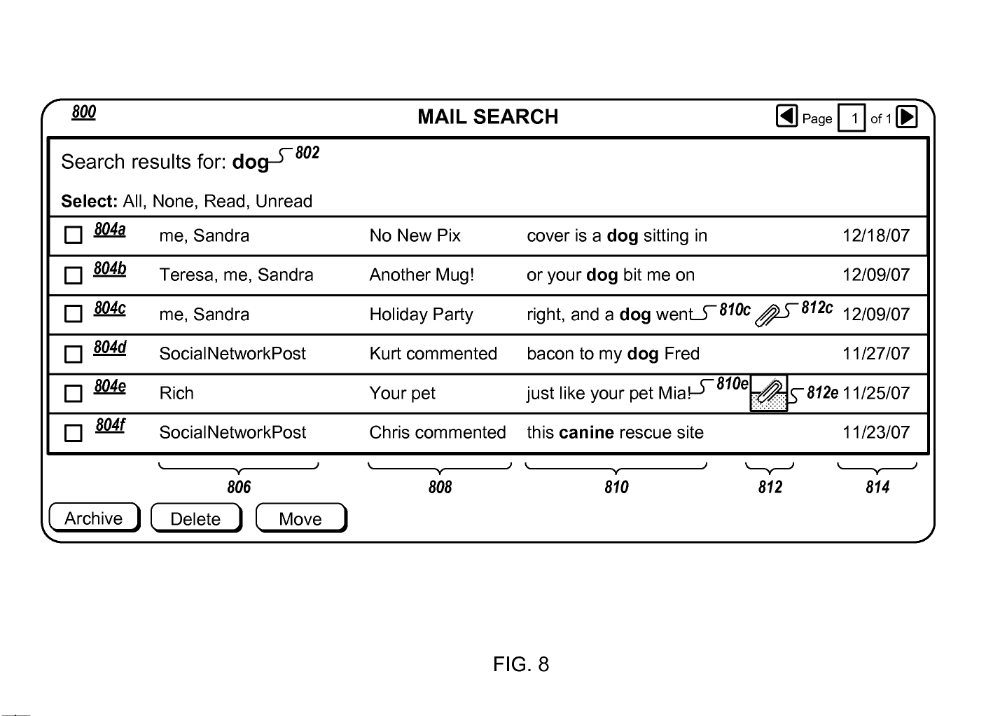

FIG. 8 illustrates an example electronic message search results interface 800 including a result with linked resources. The search results interface 800, for example, may be another feature included within the electronic message application illustrated in relation to FIGS. 7A and 7B. The search results interface 800 includes a list of search results obtained through a query 802 for the keyword “dog.” The search results include a set of electronic messages 804, each electronic message 804 including a recipient field 806 listing the recipient(s) of the electronic message 804, a title field 808 listing the subject line of the electronic message 804, a matching tokens field 810 providing the token(s) that matched the query token(s) as well as surrounding context if applicable, an attachments field 812 designating whether or not the electronic message 804 included an attachment, and a sent date field 814.

As shown in a third search result 804c, the matching tokens field 810c includes the phrase “right, and a dog went”, the term dog being highlighted. The third search result 804c includes an attachment 812c designated by a paper clip icon.

Similarly, a fifth search result 804e includes an attachment 812e. However, the attachment 812e is designated by a paper clip icon within a box. The box is approximately half shaded. In some implementations, the shading within the box illustrates the confidence with which the electronic message application has determined that the attachment matches the query 802. The fifth search result 804e, for example, matches the electronic message illustrated within FIGS. 7A and 7B. Within the matching tokens field 810e, the phrase “just like your pet Mia!” is listed, the term “pet” being the closest value to “dog” within the body text of the electronic message.

In other implementations, rather than illustrating a phrase from the body text within the matching tokens field 810e, the fifth search result 804e may include text from the summary representation 752 of the electronic message (as shown in relation to FIG. 7B). For example, the phrase “to groom your dog” from the snippet 756 could be included within the matching tokens field 810e.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

Embodiments and all of the functional operations described in this specification may be implemented in digital electronic circuitry, or in computer software, firmware, or hardware, including the structures disclosed in this specification and their structural equivalents, or in combinations of one or more of them. Embodiments may be implemented as one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any appropriate kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

To provide for interaction with a user, embodiments may be implemented on a computer having a display device, e.g., a CRT (cathode ray tube) or LCD (liquid crystal display) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any appropriate form of sensory feedback, e.g., visual feedback, auditory feedback, or tactile feedback; and input from the user may be received in any appropriate form, including acoustic, speech, or tactile input.

Embodiments may be implemented in a computing system that includes a back end component, e.g., as a data server, or that includes a middleware component, e.g., an application server, or that includes a front end component, e.g., a client computer having a graphical user interface or a Web browser through which a user may interact with an implementation, or any appropriate combination of one or more such back end, middleware, or front end components. The components of the system may be interconnected by any appropriate form or medium of digital data communication, e.g., a communication network. Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

Thus, particular embodiments have been described. Other embodiments are within the scope of the following claims. For example, the actions recited in the claims may be performed in a different order and still achieve desirable results.

What is claimed is:

1-32. (canceled)

33. A computer-implemented method comprising:
determining, by a messaging system, that a sender has initiated a transfer of an electronic message to a recipient;
before the messaging system transfers the electronic message:
determining, by the messaging system, that the electronic message includes a link to a resource, and
obtaining a summary representation of the resource that includes one or more frequently occurring terms from the resource or a feature vector associated with the resource; and
after the summary representation that includes the one or more frequently occurring terms from the resource or the feature vector associated with the resource has been stored in association with the electronic message, transferring (i) the electronic message and (ii) data referencing the summary representation that includes the one or more frequently occurring terms from the resource or the feature vector associated with the resource to the recipient.

34. The method of claim 33, wherein determining that the electronic message includes the link to the resource further comprises:
determining that the electronic message includes an incomplete link to the resource; and
deriving a full link to the resource based on the text within the electronic message.

35. The method of claim 33, wherein obtaining the summary representation that includes the one or more frequently occurring terms from the resource or the feature vector associated with the resource comprises receiving a summary representation of the resource that preexists the electronic message and that includes the one or more frequently occurring terms from the resource or the feature vector associated with the resource.

36. The method of claim 33, wherein obtaining the summary representation that includes the one or more frequently occurring terms from the resource or the feature vector associated with the resource comprises dynamically generating the summary representation that includes the one or more frequently occurring terms from the resource or the feature vector associated with the resource.

37. The method of claim 33, wherein obtaining the summary representation of the resource that includes the one or more frequently occurring terms from the resource or the feature vector associated with the resource comprises:
performing a speech recognition on the resource; and
establishing, as the summary representation that includes the one or more frequently occurring terms from the resource or the feature vector associated with the resource, a result of the speech recognition process.

38. The method of claim 33, wherein obtaining the summary representation of the resource that includes the one or more frequently occurring terms from the resource or the feature vector associated with the resource comprises:
obtaining, as the summary representation that includes the one or more frequently occurring terms from the resource or the feature vector associated with the resource, a description of or an excerpt from the resource or an automatically-generated description of an image using the resource.

39. The method of claim 33, wherein obtaining the summary representation that includes the one or more frequently occurring terms from the resource or the feature vector associated with the resource further comprises:
selecting a summarization rule associated with the link to the resource;
applying the summarization rule to the resource; and
establishing, as the summary representation that includes the one or more frequently occurring terms from the resource or the feature vector associated with the resource, a result of applying the summarization rule to the resource.

40. The method of claim 33, wherein storing the summary representation that includes the one or more frequently occurring terms from the resource or the feature vector associated with the resource in association with the electronic message comprises a server associated with a message transfer agent storing the summary representation that includes the one or more frequently occurring terms from the resource or the feature vector associated with the resource in association with the electronic message.

41. The method of claim 33, wherein storing the summary representation that includes the one or more frequently occurring terms from the resource or the feature vector associated with the resource in association with the electronic message comprises an electronic client communication device of a sender of the electronic message storing the summary representation that includes the one or more frequently occurring terms from the resource or the feature vector associated with the resource in association with the electronic message.

42. The method of claim 33, wherein the link to the resource comprises a shortened Uniform Resource Locator (URL).

43. A messaging system comprising:
one or more computers; and
a computer-readable medium coupled to the one or more computers having instructions stored thereon which, when executed by the one or more computers, cause the one or more computers to perform operations comprising:
determining, by a messaging system, that a sender has initiated a transfer of an electronic message to a recipient;
before the messaging system transfers the electronic message:
determining, by the messaging system, that the electronic message includes a link to a resource, and
obtaining a summary representation of the resource that includes one or more frequently occurring terms from the resource or a feature vector associated with the resource; and
after the summary representation that includes the one or more frequently occurring terms from the resource or the feature vector associated with the resource has been stored in association with the electronic message, transferring (i) the electronic message and (ii) data referencing the summary representation that includes the one or more frequently occurring terms from the resource or the feature vector associated with the resource to the recipient.

44. The messaging system of claim 43, wherein obtaining the summary representation that includes the one or more frequently occurring terms from the resource or the feature vector associated with the resource comprises receiving a summary representation of the resource that preexists the electronic message and that includes the one or more frequently occurring terms from the resource or the feature vector associated with the resource.

45. The messaging system of claim 43, wherein obtaining the summary representation that includes the one or more frequently occurring terms from the resource or the feature vector associated with the resource comprises dynamically generating the summary representation that includes the one or more frequently occurring terms from the resource or the feature vector associated with the resource.

46. The messaging system of claim 43, wherein obtaining the summary representation of the resource that includes the one or more frequently occurring terms from the resource or the feature vector associated with the resource comprises:
performing a speech recognition on the resource; and
establishing, as the summary representation that includes the one or more frequently occurring terms from the resource or the feature vector associated with the resource, a result of the speech recognition process.

47. The messaging system of claim 43, wherein obtaining the summary representation of the resource that includes the one or more frequently occurring terms from the resource or the feature vector associated with the resource comprises:
obtaining, as the summary representation that includes the one or more frequently occurring terms from the resource or the feature vector associated with the resource, a description of or an excerpt from the resource or an automatically-generated description of an image using the resource.

48. The messaging system of claim 43, wherein storing the summary representation that includes the one or more frequently occurring terms from the resource or the feature vector associated with the resource in association with the electronic message comprises a server associated with a message transfer agent storing the summary representation that includes the one or more frequently occurring terms from the resource or the feature vector associated with the resource in association with the electronic message.

49. The messaging system of claim 43, wherein storing the summary representation that includes the one or more frequently occurring terms from the resource or the feature vector associated with the resource in association with the electronic message comprises an electronic client communication device of a sender of the electronic message storing the summary representation that includes the one or more frequently occurring terms from the resource or the feature vector associated with the resource in association with the electronic message.

50. A non-transitory computer storage medium encoded with a computer program, the program comprising instructions that when executed by data processing apparatus cause the data processing apparatus to perform operations comprising:
determining, by a messaging system, that a sender has initiated a transfer of an electronic message to a recipient;
before the messaging system transfers the electronic message:
determining, by the messaging system, that the electronic message includes a link to a resource, and
obtaining a summary representation of the resource that includes one or more frequently occurring terms from the resource or a feature vector associated with the resource; and
after the summary representation that includes the one or more frequently occurring terms from the resource or the feature vector associated with the resource has been stored in association with the electronic message, transferring (i) the electronic message and (ii) data referencing the summary representation that includes the one or more frequently occurring terms from the resource or the feature vector associated with the resource to the recipient.

51. The medium of claim 50, wherein obtaining the summary representation that includes the one or more frequently occurring terms from the resource or the feature vector associated with the resource comprises receiving a summary representation of the resource that preexists the electronic message and that includes the one or more frequently occurring terms from the resource or the feature vector associated with the resource.

52. The medium of claim 50, wherein obtaining the summary representation that includes the one or more frequently occurring terms from the resource or the feature vector associated with the resource comprises dynamically generating the summary representation that includes the one or more frequently occurring terms from the resource or the feature vector associated with the resource.

53. The method of claim 54, wherein obtaining the summary representation of the resource that includes the one or more frequently occurring terms from the resource or the feature vector associated with the resource comprises:
determining that the resource includes an image;
obtaining a feature vector associated with the image;
identifying, based on the feature vector associated with the image, a particular object or location; and
obtaining, as the summary representation of the resource that includes the one or more frequently occurring terms from the resource or the feature vector associated with the resource, information associated with the particular object or location.
